(19) United States
(12) Patent Application Publication
(10) Pub. No.: US 2014/0199481 A1
(43) Pub. Date: Jul. 17, 2014

(54) METHOD FOR FORMING CHEMICAL LAYER AND APPARATUS FOR FORMING CHEMICAL LAYER

(71) Applicant: CANON KABUSHIKI KAISHA, Tokyo (JP)

(72) Inventors: Masaki Ohsumi, Yokosuka-shi (JP); Teruo Ozaki, Yokohama-shi (JP)

(73) Assignee: CANON KABUSHIKI KAISHA, Tokyo (JP)

(21) Appl. No.: 14/146,328

(22) Filed: Jan. 2, 2014

(30) Foreign Application Priority Data
Jan. 16, 2013 (JP) 2013-005195

(51) Int. Cl. B05D 1/00

(52) U.S. Cl. CPC B05D 1/005
USPC 427/240; 118/620; 427/565

(57) ABSTRACT

A method for forming a chemical layer on a surface of a substrate by rotationally applying a chemical, including spraying a chemical-removing solvent to a region where a filamentously entangled chemical is generated when excess of the chemical discharged to the outside of the substrate during rotational application of the chemical becomes solidified.

### BACKGROUND OF THE INVENTION

1. Field of the Invention

The present invention relates to a method for forming a chemical layer and an apparatus for forming a chemical layer.

2. Description of the Related Art

In a production method for producing a semiconductor or an inkjet head, a rotational application apparatus is used in order to form a resist layer or a resin layer on a substrate. In order to obtain a resist layer or a resin layer having an intended film thickness or distribution, the viscosity of a chemical to be applied on the substrate is adjusted; however, there is a case where such a viscosity that a cotton-candy-shaped chemical is generated in an application cup when the chemical is rotationally applied has to be chosen. When the cotton-candy-shaped chemical is deposited in the application cup, exhaust ability is sometimes deteriorated. Moreover, since the cotton-candy-shaped chemical floats in the application cup, the filamentously entangled cotton-candy-shaped chemical is sometimes reattached to the backside of the substrate.

In Japanese Patent Application Laid-Open No. H03-175617, making it easy to remove a cotton-candy-shaped chemical by providing a groove to a structure in the application cup to drain removing liquid so as to easily remove the cotton-candy-shaped chemical is disclosed. Moreover, in Japanese Patent Application Laid-Open No. S62-225268, reducing the attachment of the cotton-candy-shaped chemical by adding an air introduction path and giving a flow to the exhaust gas at the backside part are disclosed.

### SUMMARY OF THE INVENTION

A method for forming a chemical layer according to the present invention is a method for forming a chemical layer on a surface of a substrate by rotationally applying a chemical, including spraying a chemical-removing solvent to a region where a filamentously entangled chemical is generated when excess of the chemical discharged to the outside of the substrate during rotational application of the chemical becomes solidified.

In a method for producing a liquid ejection head according to the present invention, a resist layer is formed by the method for forming a chemical layer according to the present invention.

An apparatus for forming a chemical layer according to the present invention is an apparatus for forming a chemical layer by rotationally applying a chemical on a surface of a substrate to form the chemical layer, including a substrate rotating mechanism; a chemical applying mechanism for applying a chemical on a surface of a substrate; and a chemical-removing solvent spraying mechanism capable of spraying a chemical-removing solvent to a region where a filamentously entangled chemical is generated when excess of the chemical discharged to the outside of the substrate during rotational application of the chemical becomes solidified.

Further features of the present invention will become apparent from the following description of exemplary embodiments with reference to the attached drawings.

### BRIEF DESCRIPTION OF THE DRAWINGS

FIG. 1 is a cross sectional view illustrating an example of an apparatus to be used in the method according to the present invention.

FIG. 2 is a cross sectional view illustrating an example of an apparatus to be used in the conventional method.

FIGS. 3A, 3B, 3C and 3D are cross sectional views illustrating a process of a rotational application.

FIG. 4 is a cross sectional view illustrating generation of a cotton-candy-shaped chemical.

### DESCRIPTION OF THE EMBODIMENTS

Preferred embodiments of the present invention will now be described in detail in accordance with the accompanying drawings.

By the conventional technology described in Japanese Patent Application Laid-Open No. H03-175617 and Japanese Patent Application Laid-Open No. S62-225268, the cotton-candy-shaped chemical cannot be sufficiently removed. On the other hand, as a method for removing the cotton-candy-shaped chemical, it may be possible to remove the cotton-candy-shaped chemical by supplying a liquid chemical-removing solvent using a side rinse nozzle or a back rinse nozzle attached to rotational application apparatus. However, a large amount of the chemical-removing solvent is needed for sufficient removal of the cotton-candy-shaped chemical.

The present invention intends to form a chemical layer while a cotton-candy-shaped chemical is efficiently removed using a small amount of a solvent.

### Method for Forming Chemical Layer

The method for forming a chemical layer according to the present invention is a method for forming a chemical layer by rotationally applying a chemical on a surface of a substrate in which a chemical-removing solvent is sprayed to a region where a cotton-candy-shaped chemical is generated when excess of the chemical discharged to the outside of the substrate during rotational application of the chemical becomes solidified.

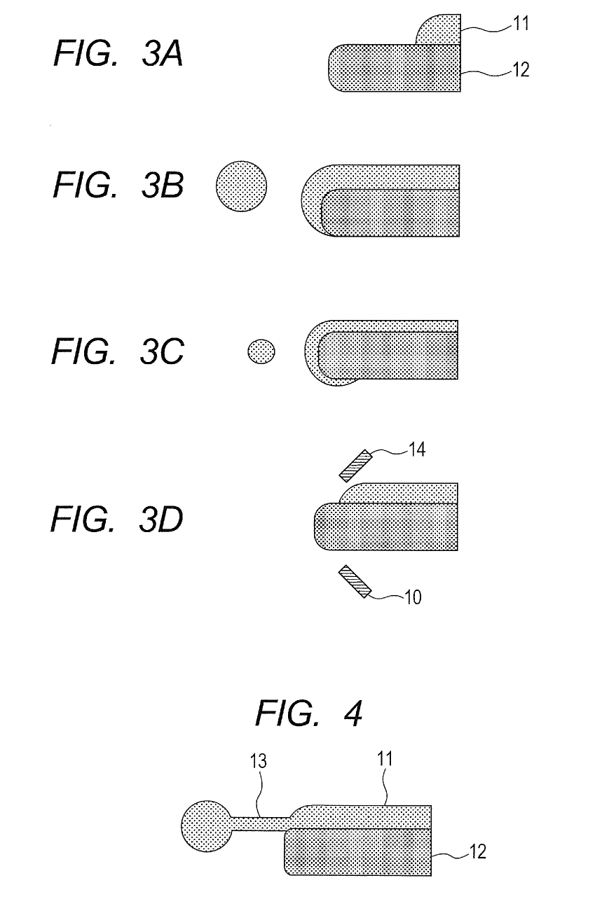

The generation process of the cotton-candy-shaped chemical will be described with reference to FIGS. 3A to 3D. A general rotational applying method is divided into (A) a process of dropping a chemical on a substrate (FIG. 3A), (B) a process of spreading the chemical on a surface of a substrate (FIG. 3B), (C) a process of obtaining a desired film thickness and uniformity (FIG. 3C) and (D) a process of processing a substrate end (FIG. 3D). In the processes (B) and (C), the excessive chemical is discharged to the outside of the substrate as illustrated in FIGS. 3B and 3C. When the evaporation of the chemical proceeds and the viscosity of the chemical increases at the time of discharging, the chemical becomes hard to be broken off and becomes solidified, and a filamentous chemical 13 is generated at the substrate end as illustrated in FIG. 4. It is supposed that the cotton-candy-shaped chemical is generated by the filamentous chemical 13 entangled to form a cotton-candy-like state. The cotton-candy-shaped chemical tends to be generated when a highly viscous chemical is used. Therefore, it is supposed that the generation of the cotton-candy-shaped chemical can be suppressed by preventing the increase in the viscosity due to the evaporation of a solvent in the chemical when the chemical is discharged to the outside of the substrate.

Accordingly, supplying a solvent to the region of the substrate end is considered. A rotational application apparatus is usually provided with a side rinse nozzle 14 or a back rinse nozzle 10 as illustrated in FIG. 2 and FIG. 3D. The generation of the cotton-candy-shaped chemical can be suppressed by supplying a liquid solvent toward the substrate end by the nozzle at the timing when the chemical is discharged to the outside of the substrate. However, in the case where the liquid solvent is supplied as it is, a large amount of a solvent is needed in order to sufficiently remove the cotton-candy-shaped chemical.

In the method according to the present invention, a chemical-removing solvent (hereinafter, also referred to as solvent) is sprayed to a region where a cotton-candy-shaped chemical is generated when excess of the chemical discharged to the outside of the substrate during rotational application of the chemical, which is selected to apply it to have a desired film thickness and distribution, becomes solidified. Thereby, effects described below can be obtained.

(1) The efficiency of removing the cotton-candy-shaped chemical is higher in the case of supplying the solvent by atomizing the solvent than in the case of supplying the liquid solvent because the area of contact of the solvent with the cotton-candy-shaped chemical is larger in the former case than in the latter case.

(2) By atomizing and supplying the solvent, the concentration of the solvent in the region where the cotton-candy-shaped chemical is generated on the outside of the substrate, such as an application cup, is raised to prevent the solidification of the chemical, the generation of the cotton-candy-shaped chemical is suppressed.

Hereinafter, details of the method according to the present invention will be described.

In the method according to the present invention, a chemical is rotationally applied on a surface of a substrate. The substrate is not particularly limited, and a silicon substrate may be used for example.

The chemical to which the method according to the present invention is applicable is not particularly limited as long as at least a part of the chemical discharged to the outside of the substrate becomes solidified and generates the cotton-candy-shaped chemical when the chemical is discharged to the outside of the substrate while the chemical is rotationally applied. For example, a solution or suspension containing an acrylic resin and a solvent for example may be used as the chemical. Examples of the solvent include propylene glycol monomethyl ether acetate (PGMEA). As a commercial product, ODUR1010 (product name, manufactured by Tokyo Ohka Kogyo Co., Ltd.) or PMER-LA900 (product name, manufactured by Tokyo Ohka Kogyo Co., Ltd.), for example, may be used. Only one kind or two or more kinds of these solvents may be used. The cotton-candy-shaped chemical tends to be generated when the viscosity of the chemical is 0.25 Pa·s or more. Moreover, the cotton-candy-shaped chemical also tends to be generated when there is an application sequence of exceeding 1000 revolutions. In such cases, the effects of the present invention are sufficiently obtained, in particular. In addition, the viscosity of the chemical is a value measured by a rotational viscometer.

In the method according to the present invention, a chemical-removing solvent is sprayed to a region where a cotton-candy-shaped chemical is generated when excess of the chemical discharged to the outside of the substrate during rotational application of the chemical becomes solidified. Here, spraying means sprinkling a liquid to an object by forming a mist of the liquid by means of an air stream or ultrasonic waves. Since a misty solvent has a higher cleaning capability than a liquid solvent, the cotton-candy-shaped chemical can efficiently be removed using a small amount of a solvent in the method according to the present invention. Moreover, the solvent can efficiently be supplied to a wider region with a smaller amount by supplying the misty solvent compared with the method of supplying the liquid solvent.

The solvent is not particularly limited as long as the solvent can dissolve a solid body of the chemical to be used. Examples of the solvent include cyclohexanone, propylene glycol monomethyl ether acetate (PGMEA) and propylene glycol monomethyl ether (PGME). Only one kind or two or more kinds of these solvents may be used. The boiling point of the solvent is preferably 100° C. or more and 180° C. or less, more preferably 120° C. or more and 160° or less. The lifetime as a mist becomes long by the boiling point of the solvent of 100° C. or more, and therefore the generation of the cotton-candy-shaped chemical can sufficiently be suppressed. Moreover, the lifetime as a mist is not too long by the boiling point of the solvent of 180° C. or less, and therefore the reattachment or the like to the surface can be suppressed. In addition, the boiling point of the solvent is a literature data.

The method for spraying the solvent is carried out by using a chemical-removing solvent spraying mechanism. The method is not particularly limited as long as the method can spray the solvent to a region where the cotton-candy-shaped chemical is generated. However, spraying using a two-fluid nozzle which sprays fine mists by mixing the solvent and a gas can be carried out from the viewpoint of apparatus cost. Moreover, spraying using an ultrasonic nozzle which sprays the solvent by forming a mist of the solvent by means of ultrasonic waves may be carried out from the viewpoint of static electricity.

The solvent is sprayed to the region where the cotton-candy-shaped chemical is generated, however, as aforementioned, it is supposed that the filamentous chemical 13 is generated at the substrate end and is then entangled to generate the cotton-candy-shaped chemical. Therefore, spraying the chemical-removing solvent at least to a substrate end is preferred.

The spraying rate of the solvent is not particularly limited as long as the generation of the cotton-candy-shaped chemical can sufficiently be suppressed.

The film thickness of the chemical layer to be formed is not particularly limited, but may be made 1 μm or more and 100 μm or less for example.

The chemical layer formed by the method according to the present invention can be utilized as a resist layer, a mold material or the like to be used in a method for producing a liquid ejection head.

### Apparatus for Forming Chemical Layer

The apparatus for forming a chemical layer according to the present invention is an apparatus for forming a chemical layer by rotationally applying a chemical on a surface of a substrate to form the chemical layer, which includes a substrate rotating mechanism, a chemical applying mechanism for applying the chemical on the surface of the substrate and a chemical-removing solvent spraying mechanism capable of spraying a chemical-removing solvent to a region where a cotton-candy-shaped chemical is generated when excess of the chemical discharged to the outside of the substrate during rotational application of the chemical becomes solidified.

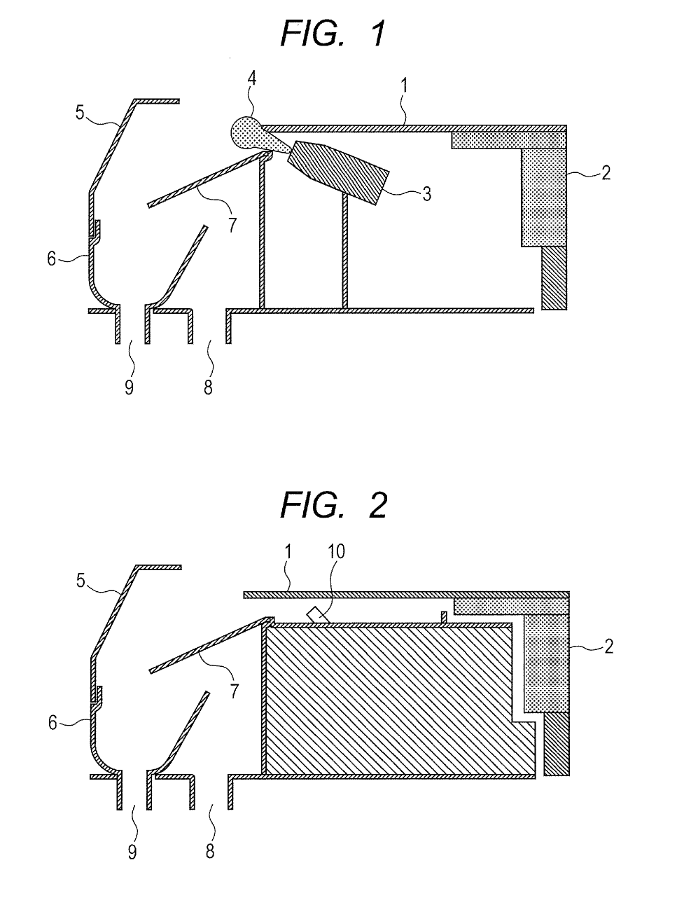

An example of an apparatus for forming a chemical layer according to the present invention is illustrated in FIG. 1. The apparatus illustrated in FIG. 1 includes a motor (not illustrated in the figure) and a substrate rotating mechanism including a chuck 2 for installing a substrate 1 installed on the upper part of the motor. Moreover, the apparatus for forming a chemical layer according to the present invention includes a chemical dropping mechanism (not illustrated in the figure) for dropping the chemical from the substrate 1 to apply the chemical on the surface of the substrate 1. Furthermore, the apparatus for forming a chemical layer according to the present invention includes a sprayer 3 capable of spraying the chemical-removing solvent to a region where the cotton-candy-shaped chemical is generated. In addition, the apparatus for forming a chemical layer according to the present invention may include one chemical-removing solvent spraying mechanism or may include a plurality of the chemical-removing solvent spraying mechanisms.

The chemical is dropped on the surface of the substrate 1 by the chemical applying mechanism while the substrate 1 arranged on the chuck 2 is rotated by the substrate rotating mechanism. The misty solvent 4 is sprayed to the end of the substrate 1 by the sprayer 3 at the same time as the chemical is spread on the substrate 1 by the rotation of the motor. Thereby, the cotton-candy-shaped chemical formed in a cotton-candy-like state by the filamentous chemical generated at the end of the substrate 1 by the excessive chemical becoming solidified and being entangled by the air stream in an upper cup 5 and an under cup 6, both being an application cup, can sufficiently be dissolved and removed. The misty solvent 4 that has dissolved the cotton-candy-shaped chemical passes through a space formed by the upper cup 5, the under cup 6 and a straightening plate 7 and is then discharged from an exhaust port 8 or a waste liquid port 9 to the outside.

### Method for Producing Liquid Ejection Head

In the method for producing a liquid ejection head according to the present invention, a resist layer is formed by the method for forming a chemical layer according to the present invention. The method for producing a liquid ejection head according to the present invention can be carried out by a publicly known photoresist process, and the formation of the resist layer is carried out by the method for forming a chemical layer according to the present invention.

### EXAMPLES

### Example 1

A chemical layer having a thickness of 10 μm was formed on the substrate 1 using ODUR1010 (product name, manufactured by Tokyo Ohka Kogyo Co., Ltd.) as a chemical by using the apparatus illustrated in FIG. 1. The apparatus illustrated in FIG. 1 in the present example includes a two-fluid nozzle manufactured by Spraying Systems Co. as the sprayer 3. ODUR1010 is a positive type resist having sensitivity to ultraviolet light and has a viscosity of 6.5 Pa·s (6500 cP). In the case of forming a chemical layer having a thickness of 10 μm using ODUR1010 by means of rotational application, excessive ODUR1010 is hard to be broken off when discharged to the outside of the substrate and then becomes solidified, so that cotton-candy-shaped ODUR1010 is generated in the application cup. Accordingly, the chemical layer was formed by the following method in the present example.

The substrate 1 was installed on the chuck 2 and then ODUR1010 was dropped from the upper part of the substrate 1 while the substrate 1 was rotated. At the time of dropping, the misty solvent 4 was sprayed toward the end of the substrate 1 from the two-fluid nozzle arranged at the back side of the substrate 1 as illustrated in FIG. 1 in order to prevent the generation of cotton-candy-shaped ODUR1010. As a solvent, ONNR-20 Thinner (product name, manufactured by Tokyo Ohka Kogyo, Co., Ltd., cyclohexanone, boiling point: 156° C.) was used. Thereby, the solidification of ODUR1010 was able to be prevented, and the generation of cotton-candy-shaped ODUR1010 was able to be prevented.

### Example 2

A chemical layer having a thickness of 7 μm was formed on the substrate 1 using PMER-LA900 (product name, manufactured by Tokyo Ohka Kogyo Co., Ltd.) as a chemical by using the apparatus illustrated by FIG. 1. The apparatus illustrated by FIG. 1 in the present example includes a two-fluid nozzle manufactured by Spraying Systems Co. as the sprayer 3. PMER-LA900 is a positive type resist for plating and has a viscosity of 0.9 Pa·s (900 cP). In the case of forming a chemical layer having a thickness of 7 μm using PMER-LA900 by means of rotational application, excessive PMER-LA900 is hard to be broken off when discharged to the outside of the substrate and then becomes solidified, so that cotton-candy-shaped PMER-LA900 is generated in the application cup. Accordingly, the chemical layer was formed by the following method in the present example.

The substrate 1 was installed on the chuck 2 and then PMER-LA900 was dropped from the upper part of the substrate 1 while the substrate 1 was rotated. At the time of dropping, the misty solvent 4 was sprayed toward the end of the substrate 1 from the two-fluid nozzle arranged at the back side of the substrate 1 as illustrated in FIG. 1 in order to prevent the generation of cotton-candy-shaped PMER-LA900. As a solvent, OK-73 (product name, manufactured by Tokyo Ohka Kogyo, Co., Ltd., PGMEA/PGME, boiling point of PGMEA: 146° C., boiling point of PGME: 120° C.). Thereby, the solidification of PMER-LA900 was able to be prevented, and the generation of cotton-candy-shaped PMER-LA900 was able to be prevented.

### Comparative Example 1

A chemical layer was formed in the same manner as in Example 1 except that a liquid solvent was supplied as it was from the back rinse nozzle 10 instead of spraying the misty solvent 4 from the two-fluid nozzle by using the apparatus illustrated in FIG. 2. The amount of the solvent used was about 2 times as much as the amount of the solvent of Example 1 used.

### Comparative Example 2

A chemical layer was formed in the same manner as in Example 2 except that a liquid solvent was supplied as it was from the back rinse nozzle 10 instead of spraying the misty solvent 4 from the two-fluid nozzle by using the apparatus illustrated in FIG. 2. The amount of the solvent used was about 2 times as much as the amount of the solvent of Example 2 used.

According to the present invention, a chemical layer can be formed while a cotton-candy-shaped chemical is efficiently removed using a small amount of a solvent.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-005195, filed Jan. 16, 2013, which is hereby incorporated by reference herein in its entirety.

What is claimed is:

1. A method for forming a chemical layer on a surface of a substrate by rotationally applying a chemical, comprising spraying a chemical-removing solvent to a region where a filamentously entangled chemical is generated when excess of the chemical discharged to the outside of the substrate during rotational application of the chemical becomes solidified.

2. The method for forming a chemical layer according to claim 1, the chemical-removing solvent is sprayed by a two-fluid nozzle.

3. The method for forming a chemical layer according to claim 1, the chemical-removing solvent is sprayed by an ultrasonic nozzle.

4. The method for forming a chemical layer according to claim 1, the chemical-removing solvent is sprayed at least to a substrate end.

5. A method for producing a liquid ejection head comprising forming a resist layer by a method according to claim 1.

6. An apparatus for forming a chemical layer by rotationally applying a chemical on a surface of a substrate to form the chemical layer, comprising:
a substrate rotating mechanism;
a chemical applying mechanism for applying a chemical on a surface of a substrate; and
a chemical-removing solvent spraying mechanism capable of spraying a chemical-removing solvent to a region where a filamentously entangled chemical is generated when excess of the chemical discharged to the outside of the substrate during rotational application of the chemical becomes solidified.

7. The apparatus for forming a chemical layer according to claim 6, wherein the chemical-removing solvent spraying mechanism is a two-fluid nozzle.

8. The apparatus for forming a chemical layer according to claim 6, wherein the chemical-removing solvent spraying mechanism is an ultrasonic nozzle.
